(19) United States
(12) Patent Application Publication
(10) Pub. No.: US 2026/0171875 A1
(43) Pub. Date: Jun. 18, 2026

(54) PRIMARY ASSEMBLY, LINEAR MOTOR, ELECTROMAGNETIC SUSPENSION AND VEHICLE

(71) Applicant: BYD COMPANY LIMITED, Shenzhen (CN)

(72) Inventors: Yingzi JIN, Shenzhen (CN); Bingqing MA, Shenzhen (CN); Guodong TAN, Shenzhen (CN); Wenming QI, Shenzhen (CN)

(73) Assignee: BYD COMPANY LIMITED, Shenzhen, GD (CN)

(21) Appl. No.: 19/530,997

(22) Filed: Feb. 5, 2026

Related U.S. Application Data
(63) Continuation of application No. PCT/CN2024/113444, filed on Aug. 20, 2024.

(30) Foreign Application Priority Data
Aug. 24, 2023 (CN) 202311078616.6

(51) Int. Cl. H02K 9/19; H02K 41/02

(52) U.S. Cl. CPC H02K 9/19; H02K 41/02

(57) ABSTRACT

A primary assembly includes an iron core with an accommodating chamber, and a separator arranged in the accommodating chamber. The separator separates the accommodating chamber along an axial direction of the accommodating chamber to form a first chamber. A drain port is in fluid communication with the first chamber and arranged in a first end region of the first chamber in the accommodating chamber. Coolant enters the first chamber via a supply port arranged in a second end region of the first chamber that includes the separator. The coolant is discharged out of the accommodating chamber via the drain port.

### CROSS-REFERENCE TO RELATED APPLICATIONS

The present application is a continuation of International Application No. PCT/CN 2024/113444, filed on Aug. 20, 2024, which claims priority to Chinese Patent Application No. 202311078616.6, filed on Aug. 24, 2023. The entire disclosures of the prior applications are hereby incorporated herein by reference.

### FIELD

The present disclosure relates to the field of driving devices, including to a primary assembly, a linear motor, an electromagnetic suspension, and a vehicle.

### BACKGROUND

A linear motor is an electric motor which directly converts electrical energy into mechanical energy of linear motion without an intermediate conversion device, which can omit an intermediate conversion device, thereby reducing the space occupied by a device and improving the system efficiency. As a structural form of the linear motor, a cylindrical linear motor is one example. The cylindrical linear motor has the advantages of high running efficiency, high power density and high force density, good servo performance, etc.

A cylindrical linear motor still has disadvantages. For example, when a large electric current is applied to a primary winding, a large amount of heat is easily generated, thereby causing problems such as demagnetization of a permanent magnet and even breakdown of the motor, consequently, heat dissipation from the primary winding becomes a challenge.

### SUMMARY

The present disclosure is intended to address some of the technical problems in the related art at least to some extent.

To this end, one object of the present disclosure is to provide a primary assembly, in which when coolant is delivered into the interior of an iron core, the primary assembly is cooled by means of the coolant. In an example, coolant enters a first chamber in an accommodating chamber of an iron core via a supply port to dissipate heat from the primary assembly, and then the cooling of the linear motor where the primary assembly is applied can be achieved.

An object of the present disclosure is to provide a linear motor.

An object of the present disclosure is to provide an electromagnetic suspension.

An object of the present disclosure is to provide a vehicle.

In some embodiments of the present disclosure, the primary assembly includes an iron core with an accommodating chamber, and a separator arranged in the accommodating chamber. The separator separates the accommodating chamber along an axial direction of the accommodating chamber to form a first chamber. A drain port is in fluid communication with the first chamber and arranged in a first end region of the first chamber in the accommodating chamber. Coolant enters the first chamber via a supply port arranged in a second end region of the first chamber that includes the separator. The coolant is discharged out of the accommodating chamber via the drain port.

In some embodiments of the present disclosure, the primary assembly according to the present disclosure, includes an iron core, a separator, and a drain port. The iron core is provided with an accommodating chamber. The separator is arranged in the accommodating chamber, and the separator separates the accommodating chamber along the axial direction of the accommodating chamber to form a first chamber. The drain port is in fluid communication with the first chamber, and the drain port is arranged away from the separator. Coolant enters the first chamber via a supply port disposed close to the separator, and is discharged out of the accommodating chamber via the drain port.

In some embodiments of the present disclosure, when coolant is delivered into the interior of an iron core, the primary assembly is cooled by means of the coolant. In an embodiment, coolant enters a first chamber in an accommodating chamber of the iron core via a supply port to dissipate heat from the primary assembly, and then the cooling of a linear motor where the primary assembly is applied can be achieved.

In some embodiments of the present disclosure, a linear motor includes the above-described primary assembly.

In an aspect of the present disclosure, a primary assembly is applicable to a water-cooled linear motor, and an accommodating chamber for circulation of coolant is configured on the iron core, thereby enabling timely dissipation of heat generated by coils. A supply port for delivering coolant into a first chamber of the accommodating chamber is arranged close to the separator, and a drain port for discharging coolant out of the accommodating chamber is arranged away from the separator, so that dead zones in the accommodating chamber can be minimized to the extent possible, the fluidity of coolant is improved, and the heat dissipation ability is enhanced.

In an aspect of the present disclosure, an electromagnetic suspension includes the above-described linear motor.

In an aspect of the present disclosure, the vehicle includes the above-described electromagnetic suspension.

Examples of aspects and advantages of the present disclosure are provided in the following description, some of which will become apparent from the description, or may be learned through practice of the present disclosure.

### BRIEF DESCRIPTION OF THE DRAWINGS

FIG. 1 is a first structural schematic diagram of a primary assembly according to an embodiment of the present disclosure;

FIG. 2 is a second structural schematic diagram of a primary assembly according to an embodiment of the present disclosure;

FIG. 3 is a structural schematic diagram of a linear motor according to an embodiment of the present disclosure;

FIG. 4 is a structural schematic diagram of an electromagnetic suspension according to an embodiment of the present disclosure; and

FIG. 5 is a structural schematic diagram of a vehicle according to an embodiment of the present disclosure.

### DETAILED DESCRIPTION

Examples of embodiments of the present disclosure are described below in further detail. Examples of the embodiments are shown in the accompanying drawings, and same or similar reference signs indicate same or similar components or components having same or similar functions. The embodiments described below, with reference to the accompanying drawings, are provided as examples to facilitate understanding of the present disclosure and are not intended to limit the scope the present disclosure.

In the related art, both oil cooling and water cooling can be used for linear motors. When water cooling is employed, challenges include insulating between cooling water from a winding and achieving highly efficient and rapid circulation of the cooling water exist.

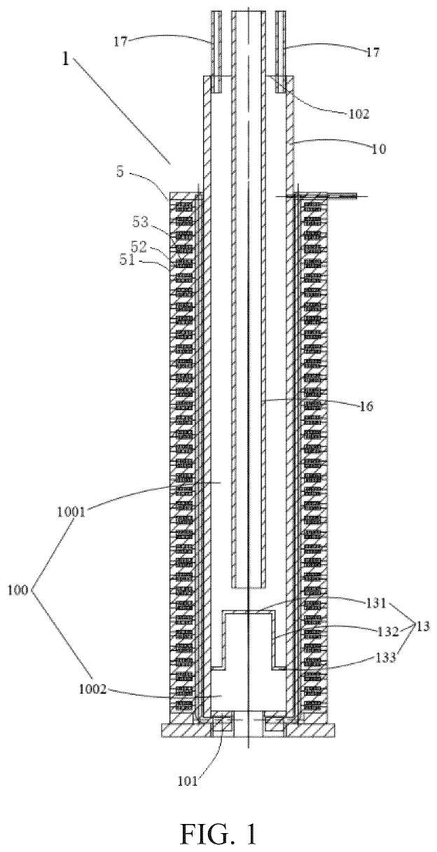

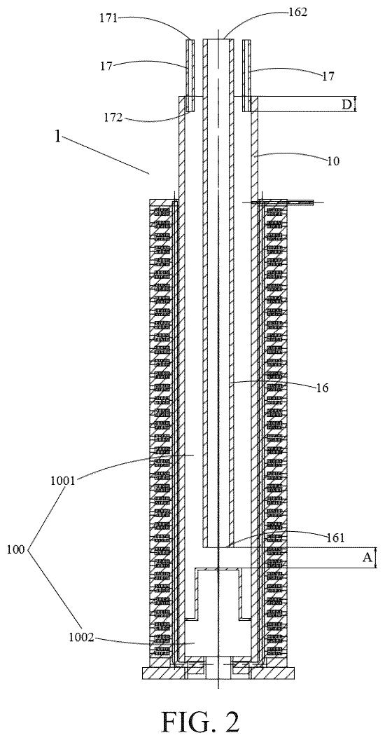

A primary assembly 1 according to an embodiment of the present disclosure will be described below with reference to the accompanying drawings. As shown in FIG. 1 to FIG. 2, according to an embodiment of the present disclosure, a primary assembly 1 is provided. The primary assembly 1 includes an iron core 5, the iron core is provided with an accommodating chamber 100. The assembly 1 further includes a separator 13, a supply port 161, and a drain port 172. The separator 13 is arranged in the accommodating chamber 100, and the separator 13 separates the accommodating chamber 100 along the axial direction of the accommodating chamber 100 to form a first chamber 1001.

The drain port 172 is in fluid communication with the first chamber 1001, and the drain port 172 is arranged away from the separator 13. Coolant enters the first chamber 1001 via the supply port 161 disposed close to the separator 13, and is discharged out of the accommodating chamber 100 via the drain port 172. In an example, the drain port 172 is in fluid communication with the first chamber and arranged in a first end region of the first chamber in the accommodating chamber.

In an embodiment, the supply port 161 is arranged in the first chamber 1001, and is arranged close to the separator 13. In an example, the supply port 161 is arranged in a second end region of the first chamber that includes the separator.

In a primary assembly 1 according to the embodiment of the present disclosure, when coolant is delivered into the interior of an iron core 5, the primary assembly 1 is cooled by means of the coolant. For example, coolant enters a first chamber in an accommodating chamber 100 of the iron core 5 via a supply port 161 to dissipate heat from the primary assembly 1, and then the cooling of a linear motor 6 where the primary assembly 1 is applied can be achieved.

The primary assembly 1 according to the embodiment of the present disclosure is applicable, for example, to a water-cooled linear motor 6. An accommodating chamber for circulation of coolant is configured on the iron core 5, thereby enabling timely dissipation of heat generated by a coil 53. A supply port for delivering coolant into a first chamber of the accommodating chamber is arranged close to the separator, and a drain port for discharging coolant out of the accommodating chamber is arranged away from the separator, so that dead zones in the accommodating chamber can be reduced to the extent possible, the fluidity of coolant is improved, and the heat dissipation ability is enhanced.

After flowing out from a supply port 161 of a coolant inlet pipe 16, coolant enters a first chamber 1001 of an accommodating chamber 100 of a primary core shaft 10, and then coolant continues to flow for cooling until flowing out of the accommodating chamber 100 from a drain port 171.

In a primary assembly 1 according to some embodiments of the present disclosure, the coolant inlet pipe 16 for delivering coolant is at least partially distributed in a hollow structure of a primary core shaft 10, and the coolant exerts a cooling effect inside the primary core shaft 10, thereby achieving a better cooling and heat dissipation effect. The coolant inlet pipe 16 is at least partially arranged in the hollow structure of the primary core shaft 10, which can save the space outside the primary core shaft 10, thereby conducive to the miniaturized design of a linear motor 6 where the primary assembly 1 is applied.

As shown in FIG. 1, in an embodiment, an iron core 5 includes a plurality of iron core bodies 51 and a primary core shaft 10.

The plurality of iron core bodies 51 are arranged in a stacked manner along the axial direction of the iron core 5, each iron core body 51 is configured with at least one annular accommodating groove 52, and a coil 53 is arranged in the accommodating groove 52.

The primary core shaft 10 is coaxial with and fixedly connected to the iron core bodies 51, the primary core shaft 10 is a hollow shaft, and a central hole of the primary core shaft 10 forms the accommodating chamber 100.

In an embodiment, when cooling water is used as the cooling medium, the cooling water needs to be separated from the coil 53, and the arrangement of the primary core shaft 10 can isolate, for example completely isolate, the cooling water from the coil 53, thereby improving the safety of the linear motor 6. In addition, the coolant is delivered into the hollow structure of the primary core shaft 10, and the coolant exerts a cooling effect inside the primary core shaft 10, so that a better cooling and heat dissipation effect can be achieved.

As shown in FIG. 1, in an embodiment, the primary assembly 1 further includes a coolant inlet pipe 16 and/or a coolant outlet pipe 17. A supply port 161 is disposed on the coolant inlet pipe 16. A drain port 172 is disposed on the coolant outlet pipe 17.

The supply port 161 and the drain port 172 are both disposed in the accommodating chamber 100. In addition, the coolant inlet pipe 16 has a coolant inlet A, and the coolant inlet A is disposed outside the accommodating chamber 100.

In an embodiment, the coolant inlet pipe 16 and the coolant outlet pipe 17 for delivering the coolant are at least partially distributed in the hollow structure of the primary core shaft 10, so that the space outside the primary core shaft 10 can be saved, thereby conducive to the miniaturized design of a linear motor 6 where the primary assembly 1 is applied.

As shown in FIG. 1, in an embodiment, the coolant inlet pipe 16 is disposed coaxially with the accommodating chamber 100, and an outer diameter of the coolant inlet pipe 16 is smaller than an inner diameter of the accommodating chamber 100.

The coolant outlet pipe 17 is arranged at a side of the coolant inlet pipe 16 in the radial direction.

In an embodiment, the coolant outlet pipe 17 is arranged at the side of the coolant inlet pipe 16 in the radial direction, so that the coolant can not only flow along the axial direction of the coolant inlet pipe 16 for cooling, but also flow in the radial direction of the coolant inlet pipe 16 during the process of the coolant flowing from the supply port 161 of the coolant inlet pipe 16 to the drain port 172 of the coolant outlet pipe 17, thereby achieving a more sufficient cooling and heat dissipation effect.

As shown in FIG. 1, in an embodiment, at least two coolant outlet pipes 17 are provided. In an example, the coolant outlet pipes 17 are evenly arranged along a circumference direction of the coolant inlet pipe 16.

In an embodiment, the coolant flows out from the supply port 161 of the coolant inlet pipe 16, and flows in the radial direction of the coolant inlet pipe 16 to the coolant outlet pipes 17 evenly distributed along a circumference of the coolant inlet pipe 16, so that the cooling and heat dissipation effect of the coolant is more sufficient and uniform.

As shown in FIG. 1, in an embodiment, along the axial direction of the iron core 5, a length D of the coolant outlet pipe 17 located within the first chamber 1001 is less than 10 mm.

In an embodiment, it can be understood that the accommodating chamber 100 of the primary core shaft 10 is configured with an opening portion, and a part of the coolant inlet pipe 16 and a part of the coolant outlet pipe 17 both protrude out of the accommodating chamber 100 through the opening portion of the accommodating chamber 100;

In some embodiments, the length D of the coolant outlet pipe 17 arranged in the first chamber 1001 is set to be less than 10 mm, i.e., in a first direction, the distance between the drain port 172 and the opening portion of the accommodating chamber 100 is less than 10 mm. Therefore, the coolant enters the coolant outlet pipe 17 via the drain port 172 only at a position less than 10 mm away from the opening of the accommodating chamber 100, which more effectively ensures that the coolant flows sufficiently in the first chamber 1001 of the accommodating chamber 100 to achieve a sufficient cooling effect before entering the coolant outlet pipe 17 and then the coolant leaves the first chamber 1001.

As shown in FIG. 1, in an embodiment, a minimum distance A between the supply port 161 and the separator 13 along the axial direction of the iron core 5 ranges from 5 mm to 10 mm.

If the supply port 161 is too close to the separator 13, the coolant will encounter obvious resistance when flowing from the supply port 161 to the separator 13, which may cause unsmooth flow of the coolant. If the supply port 161 is too far from the separator 13, the coolant needs to flow a long distance to reach the separator 13 after flowing out of the supply port 161, so that the coolant inlet pipe 16 cannot provide a good cooling guide path for the coolant.

Therefore, in an embodiment, the minimum distance A between the supply port 161 and the separator 13 in the first direction is set as a range from 5 mm to 10 mm, which provides a good cooling guide path for the coolant while ensuring smooth flow of the coolant.

As shown in FIG. 1, in an embodiment, a primary core shaft 10 includes an end cover 101 and an opening portion 102 arranged opposite each other along the axial direction of the primary core shaft 10, and a separator 13 is arranged close to the end cover 101.

The end cover 101 is provided with a guide hole being coaxial with the accommodating chamber 100 and in communication with the accommodating chamber 100, and the guide hole is configured for a guide rod of a linear motor 6 to pass through.

The separator 13 further separates the accommodating chamber 100 along the axial direction of the accommodating chamber 100 to form a second chamber 1002 to provide a space for the movement of the guide rod.

In an embodiment, the guide rod of the linear motor 6 passes through the end cover 101 and enters the second chamber 1002, and the second chamber 1002 provides a partial stroke for the movement of the guide rod, thereby conducive to the miniaturized design of the linear motor 6.

As shown in FIG. 1, in an embodiment, the separator 13 includes:

a first plate 131;

a cylindrical side wall 132 arranged around the first plate 131, the cylindrical side wall 132 extends along an axial direction of the accommodating chamber 100, one end of the cylindrical side wall 132 close to the supply port 161 is connected to the first plate 131, and the cylindrical side wall 132 and the first plate 131 together form a portion of the second chamber 1002.

A second plate 133 is arranged around the cylindrical side wall 132, one side of the second plate 133 is connected to one end of the cylindrical side wall 132 away from the supply port 161, and the other side is connected to the iron core 5. The connection may be a direct connection or an indirect connection.

In an embodiment, the above structure of the separator 13 can reduce the axial length of the iron core 5 for a given stroke of the linear motor 6.

Furthermore, in an embodiment, the cylindrical side wall 132 is a cylindrical structure disposed coaxially with the accommodating chamber 100. The first plate 131 is disc-shaped, and a diameter of the first plate 131 is greater than ½ of an inner diameter of the accommodating chamber 100.

As shown in FIG. 1, in an embodiment, the primary assembly 1 further includes a coolant inlet pipe 16. A supply port 161 is formed in the coolant inlet pipe 16.

Along the axial direction of the iron core 5, the cylindrical side wall 132 has a first length, and the coolant inlet pipe 16 has a second length within the first chamber 1001. The first length is less than the second length.

In an embodiment, the length of the coolant inlet pipe 16 in the first chamber 1001 is set to be greater than the length of the separator 13 along the first direction, so that the coolant inlet pipe 16 is more fully arranged in the space of the first chamber 1001 along the first direction, thereby further ensuring that the coolant inlet pipe 16 provides a good cooling guide path for the coolant.

In addition, a full arrangement of the coolant inlet pipe 16 in the space of the first chamber 1001 along the first direction is also conducive to reduce the space occupied by the coolant inlet pipe 16 outside the primary core shaft 10.

According to some embodiments of the present disclosure, a linear motor 6 is provided, which includes the primary assembly 1 as described above.

In an embodiment, the linear motor 6 further includes a secondary assembly 2. The secondary assembly 2 is sheathed outside the primary assembly 1, and the secondary assembly 2 and the primary assembly 1 can move relative to each other along the axial direction of the iron core 5.

In an embodiment, relative movement can be performed between the primary assembly 1 and the secondary assembly 2, and the relative movement is a translational movement along the axial direction of the primary core shaft 10, which is the above-mentioned first direction.

For example, the primary assembly 1 is a stator, i.e., the primary assembly 1 is stationary, whereas the secondary assembly 2 is a rotor, i.e., the secondary assembly 2 performs translational movement relative to the primary assembly 1.

In the linear motor 6 provided in an embodiment of the present disclosure, an accommodating chamber for circulation of coolant is configured on the iron core 5, thereby enabling timely dissipation of heat generated by a coil 53. A supply port for delivering coolant into a first chamber of the accommodating chamber is arranged close to the separator, and a drain port for discharging coolant out of the accommodating chamber is arranged away from the separator, so that dead zones in the accommodating chamber can be reduced to the extent possible, the fluidity of coolant is improved, and the heat dissipation ability is enhanced.

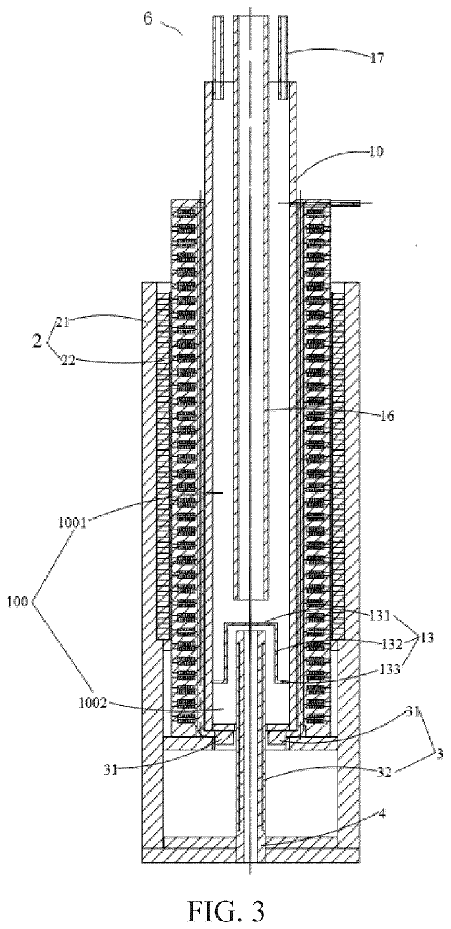

As shown in FIG. 3, in an embodiment, the secondary assembly 2 includes a sleeve 21 and a magnetic steel 22 fixed to an inner side wall of the sleeve 21. The sleeve 21 is coaxially arranged with the iron core 5, and the sleeve 21 is sheathed on an outer periphery of the iron core 5.

As shown in FIG. 3, in an embodiment, the linear motor 6 further includes a guide rod 4, wherein the guide rod 4 is coaxially arranged with the accommodating chamber, one end of the guide rod 4 is connected to one end of the sleeve 21 away from the first chamber 1001, and the other end of the guide rod 4 is disposed within the second chamber 1002 and the guide rod 4 can move inside the second chamber 1002.

In an embodiment, a part of the guide rod 4 extends into the second chamber 1002 and can move inside the second chamber 1002, which is conducive to reduce the length of the linear motor 6 in the axial direction.

As shown in FIG. 1, in an embodiment, the linear motor 6 further includes a sensor 3. The sensor 3 includes a sensor readhead 31 and a magnetic grid strip 32. The sensor readhead 31 is connected to the iron core 5.

The magnetic grid strip 32 is configured on the guide rod 4. The sensor readhead 31 and the magnetic grid strip 32 move relative to each other, and the sensor readhead 31 and the magnetic grid strip 32 cooperate with each other to detect positional change thereof.

In an embodiment, in order to detect the relative positional relationship of the translational movement between the primary assembly 1 and the secondary assembly 2, the linear motor 6 is configured with a sensor 3, and the sensor 3 is configured with a sensor readhead 31 and a magnetic grid strip 32.

The sensor readhead 31 is connected to the primary core shaft 10 of the primary assembly 1, and when the primary assembly 1 is a stator, the sensor readhead 31 is stationary. The magnetic grid strip 32 is connected to the secondary assembly 2, and when the secondary assembly 2 is a rotor, the magnetic grid strip 32 moves translationally along with the secondary assembly 2.

The separator 13 divides the accommodating chamber 100 of the primary core shaft 10 into a first chamber 1001 and a second chamber 1002. The first chamber 1001 is arranged close to the opening of the accommodating chamber 100, whereas the second chamber 1002 is arranged further away from the opening of the accommodating chamber 100.

A partial structure of the coolant inlet pipe 16 for delivering coolant and a partial structure of the coolant outlet pipe 17 are arranged in the first chamber 1001, and a partial structure of the sensor 3 is arranged in the second chamber 1002. For example, the separator 13 isolates the coolant from the sensor 3, thereby preventing the coolant from entering the sensor 3 and damaging it; and the space of the entire accommodating chamber 100 is more fully utilized.

Furthermore, the separator 13 includes a first plate 131, a cylindrical side wall 132 surrounding the first plate 131, and a second plate 133 surrounding the cylindrical side wall 132. The cylindrical side wall 132 extends along an axial direction of the accommodating chamber 100. One end of the cylindrical side wall 132 close to the supply port 161 is connected to the first plate 131, and the cylindrical side wall 132 and the first plate 131 together define a portion of the second chamber 1002. One side of the second plate 133 is connected to one end of the cylindrical side wall 132 away from the supply port 161, and the other side is connected to the iron core 5.

In an embodiment, a part of the magnetic grid strip 32 extends into the cylindrical side wall 132 of the separator 13 along with the guide rod 4. For example, the space inside the cylindrical side wall 132 provides a certain stroke for the translational movement of the magnetic grid strip 32 relative to the sensor readhead 31 along the first direction, thus reducing the size of the linear motor 6 along the first direction and resulting in a more compact overall structure of the linear motor 6.

In addition, the space around the outside of the cylindrical side wall 132 provides a flow path for the coolant. For example, after the coolant flows out from the supply port 161 and reaches the first plate 131 of the separator 13, a part of the coolant continues to flow toward the second plate 133 of the separator 13, and the space between the outer side of the cylindrical side wall 132 and the inner side wall of the primary core shaft 10 expands the flow stroke of the coolant, so that the coolant further exerts a cooling effect between the outer side of the cylindrical side wall 132 and the inner side wall of the primary core shaft 10.

As shown in FIG. 3, in an embodiment, a coolant inlet pipe 16, a primary core shaft 10, and a cylindrical side wall 132 are all coaxially disposed.

In this specific embodiment, the coolant inlet pipe 16, the primary core shaft 10, and the cylindrical side wall 132 of the separator 13 are all coaxially disposed, thereby facilitating more uniform cooling and heat dissipation of the linear motor 6 by the coolant.

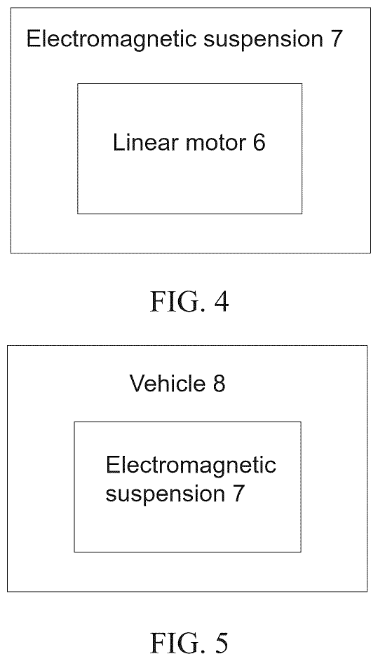

As shown in FIG. 4, an electromagnetic suspension 7 is provided according to some embodiments of the present disclosure. The electromagnetic suspension 7 includes the linear motor 6 of any of the above embodiments.

As shown in FIG. 5, a vehicle 8 is provided according to some embodiments of the present disclosure. The vehicle includes the electromagnetic suspension 7 according to the any of the above embodiments.

In the description of the present disclosure, it should be understood that the orientation or positional relationships indicated by the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. are based on the orientation or positional relationships shown in the drawings, and are only for the convenience of describing the present disclosure and simplifying the description, rather than indicating or implying that the indicated device or element must have a specific orientation, be constructed and operated in a specific orientation, and therefore shall not be understood as limiting the present disclosure.

In addition, terms “first” and “second” are used merely for the purpose of description, and shall not be construed as indicating or implying relative importance or implying a quantity of indicated technical features. Therefore, a feature restricted by “first” or “second” may explicitly indicate or implicitly include at least one of such features. In the descriptions of the present disclosure, unless explicitly specified, “a plurality of” means two or more.

In the present disclosure, it should be noted that unless otherwise explicitly specified and limited, the terms “mount”, “connect”, “connection”, and “fix” should be understood in a broad sense. For example, it may be a fixed connection, a detachable connection, or an integral connection; or it may be a mechanical connection or an electrical connection; or it may be a direct connection, an indirect connection through an intermediary, or internal communication between two elements or mutual action relationship between two elements, unless otherwise specified explicitly. A person of ordinary skill in the art will understand the meanings of the terms in the present disclosure from the context of the present disclosure.

In the present disclosure, it should be noted that unless otherwise explicitly specified and limited, a first feature being “on” or “under” a second feature may mean that the first feature is in direct contact with the second feature, or that the first feature is in indirect contact with the second feature through an intermediate medium. Furthermore, a first feature being “on”, “above”, or “on top of” a second feature may mean that the first feature is directly above or obliquely above the second feature, or simply means that the first feature is at a higher level than the second feature. A first feature being “below”, “under”, or “on the bottom of” a second feature may mean that the first feature is directly below or obliquely below the second feature, or simply means that the first feature is at a lower level than the second feature.

In the description of this specification, the description of the reference terms “an embodiment”, “some embodiments”, “an example”, “a specific example”, “some examples”, and the like means that specific features, structures, materials or characteristics described in combination with the embodiment(s) or example(s) are included in at least one embodiment or example of the present disclosure. In this specification, examples of descriptions of the foregoing terms do not necessarily refer to the same embodiment or example. In addition, the described features, structures, materials, or characteristics may be combined in any proper manner in any one or more of the embodiments or examples. In addition, a person of ordinary skill in the art can combine and integrate different embodiments or examples and features of different embodiments or examples described in this specification without conflicting with each other.

Although the embodiments of the present disclosure have been shown and described above, it can be understood that, the foregoing embodiments are merely examples and should not be understood as limiting the scope of the present disclosure. A person of ordinary skill in the art can make changes, modifications, replacements, or variations to the foregoing embodiments within the scope of the present disclosure.

What is claimed is:

1. A primary assembly, comprising:
an iron core with an accommodating chamber;
a separator arranged in the accommodating chamber, the separator separating the accommodating chamber along an axial direction of the accommodating chamber to form a first chamber; and
a drain port in fluid communication with the first chamber and arranged in a first end region of the first chamber in the accommodating chamber, wherein
coolant enters the first chamber via a supply port arranged in a second end region of the first chamber that includes the separator, and
the coolant is discharged out of the accommodating chamber via the drain port.

2. The primary assembly according to claim 1, further comprising:
the supply port, wherein the supply port is greater than or equal to a minimum distance and less than or equal to a maximum distance from the separator.

3. The primary assembly according to claim 1, wherein the iron core comprises:
a plurality of iron core bodies stacked along the axial direction of the iron core, each iron core body including at least an annular groove and a coil arranged in the annular groove; and
a primary core shaft coaxial with and fixed to the plurality of iron core bodies, the primary core shaft having a central hole that forms the accommodating chamber.

4. The primary assembly according to claim 1, further comprising:
a coolant inlet pipe, the supply port being disposed on the coolant inlet pipe; and/or
a coolant outlet pipe, the drain port being disposed on the coolant outlet pipe.

5. The primary assembly according to claim 4, wherein
the coolant inlet pipe is coaxial with the accommodating chamber,
an outer diameter of the coolant inlet pipe is smaller than an inner diameter of the accommodating chamber, and
the coolant outlet pipe is arranged at a side of the coolant inlet pipe in the radial direction.

6. The primary assembly according to claim 1, further comprising:
a plurality of coolant outlet pipes, wherein
the plurality of coolant outlet pipes are evenly arranged along a circumference direction of a coolant inlet pipe.

7. The primary assembly according to claim 4, wherein along the axial direction of the iron core, a length D of the coolant outlet pipe located within the first chamber is less than 10 mm.

8. The primary assembly according to claim 1, wherein a minimum distance A between the supply port and the separator along the axial direction of the iron core ranges from 5 mm to 10 mm.

9. The primary assembly according to claim 3, wherein
the primary core shaft includes an end cover and an opening portion arranged opposite each other along the axial direction of the primary core shaft;
the end cover is provided with a guide hole that is coaxial with the accommodating chamber and in communication with the accommodating chamber;
the guide hole is configured to pass through a guide rod of a linear motor; and
the separator separates the accommodating chamber along the axial direction of the accommodating chamber to form a second chamber that provides a space for movement of the guide rod.

10. The primary assembly according to claim 9, wherein
the separator comprises:
a first plate;
a cylindrical side wall arranged around the first plate, the cylindrical side wall extending along the axial direction of the accommodating chamber, a first end of the cylindrical side wall being connected to the first plate, the cylindrical side wall and the first plate forming a portion of the second chamber;
a second plate arranged around the cylindrical side wall, a first side of the second plate being connected to a second end of the cylindrical side wall, and a second side of the second plate being connected to the iron core, and
the first end of the cylindrical side wall is closer to the supply port than the second end of the cylindrical side wall.

11. The primary assembly according to claim 10, wherein the cylindrical side wall is coaxial with the accommodating chamber.

12. The primary assembly according to claim 10, wherein
the first plate is disc-shaped, and
a diameter of the first plate is greater than ½ of an inner diameter of the accommodating chamber.

13. The primary assembly according to claim 10, wherein
the primary assembly includes a coolant inlet pipe, the supply port being disposed on the coolant inlet pipe; and
along the axial direction of the iron core, the cylindrical side wall has a first length, and the coolant inlet pipe has a second length within the first chamber, the first length being less than the second length.

14. A linear motor, comprising:
a primary assembly including:
an iron core with an accommodating chamber;
a separator arranged in the accommodating chamber, the separator separating the accommodating chamber along an axial direction of the accommodating chamber to form a first chamber; and
a drain port in fluid communication with the first chamber and arranged in a first end region of the first chamber in the accommodating chamber, wherein
coolant enters the first chamber via a supply port arranged in a second end region of the first chamber that includes the separator, and
the coolant is discharged out of the accommodating chamber via the drain port.

15. The linear motor according to claim 14, further comprising:
a secondary assembly sheathed outside the primary assembly, wherein
the secondary assembly and the primary assembly are configured to move relative to each other along the axial direction of the iron core.

16. The linear motor according to claim 15, wherein
the secondary assembly includes a sleeve and magnetic steel fixed to an inner side wall of the sleeve,
the sleeve is arranged coaxially with the iron core, and
the sleeve is sheathed on an outer periphery of the iron core.

17. The linear motor according to claim 16, further comprising:
a guide rod arranged coaxially with the accommodating chamber, wherein
a first end of the guide rod is connected to the sleeve,
a second end of the guide rod is disposed within a second chamber, and
the guide rod is configured to move inside the second chamber.

18. The linear motor according to claim 17, further comprising:
a sensor including:
a sensor readhead connected to the iron core; and
a magnetic grid strip on the guide rod, wherein
the sensor readhead and the magnetic grid strip are configured to move relative to each other, and
the sensor readhead and the magnetic grid strip are configured to detect positional changes.

19. An electromagnetic suspension, comprising:
a linear motor with a primary assembly, the primary assembly including:
an iron core with an accommodating chamber;
a separator arranged in the accommodating chamber, the separator separating the accommodating chamber along an axial direction of the accommodating chamber to form a first chamber; and
a drain port in fluid communication with the first chamber and arranged in a first end region of the first chamber in the accommodating chamber, wherein
coolant enters the first chamber via a supply port arranged in a second end region of the first chamber that includes the separator, and
the coolant is discharged out of the accommodating chamber via the drain port.

20. A vehicle, comprising:
the electromagnetic suspension according to claim 19.
